(19) United States
(12) Patent Application Publication
(10) Pub. No.: US 2013/0253932 A1
(43) Pub. Date: Sep. 26, 2013

(54) CONVERSATION SUPPORTING DEVICE, CONVERSATION SUPPORTING METHOD AND CONVERSATION SUPPORTING PROGRAM

(71) Applicant: KABUSHIKI KAISHA TOSHIBA, Tokyo (JP)

(72) Inventors: Masahide ARIU, Kanagawa (JP); Kazuo Sumita, Kanagawa (JP); Akinori Kawamura, Tokyo (JP)

(73) Assignee: Kabushiki Kaisha Toshiba, Tokyo (JP)

(21) Appl. No.: 13/776,344

(22) Filed: Feb. 25, 2013

(30) Foreign Application Priority Data
Mar. 21, 2012 (JP) 2012-064231

(51) Int. Cl. G10L 15/22

(52) U.S. Cl. CPC G10L 15/22
USPC 704/246

(57) ABSTRACT

A conversation supporting device of an embodiment of the present disclosure has a information storage unit, a recognition resource constructing unit, and a voice recognition unit. Here, the information storage unit stores the information disclosed by a speaker. The recognition resource constructing unit uses the disclosed information to construct the recognition resource including a voice model and a language model for recognition of voice data. The voice recognition unit uses the recognition resource to recognize the voice data.

### CROSS-REFERENCE TO RELATED APPLICATION

This application is based upon and claims the benefit of priority from Japanese Patent Application No. 2012-064231, filed Mar. 21, 2012; the entire contents of which are incorporated herein by reference.

### FIELD

Embodiments described herein relate generally to a conversation supporting device, a conversation supporting method and a conversation supporting program.

### BACKGROUND

There is a technology that uses voice recognition to recognize the voice and speech in the context of normal, everyday conversations and to record the conversation contents as text. In this case, by switching the language model used for recognizing the speaker's speech to a model more closely corresponding to the conversation contents, it is possible to improve the recognition accuracy of the recording technology.

However, in the related art, switching of the language model is carried out only for both (all) speakers in the conversation (e.g., a customer and telephone operator), and when the conversation includes names (such as the name of the conversation counterpart), an acronym (such as an abbreviated name of an organization), or other specific information related to a particular context, it is difficult to correctly recognize those sounds. Specific information about a speaker or speakers can be collected to improve voice recognition performance, but if the entirety of the information that has been collected or input about a certain speaker is sent to or is otherwise accessible by another speaker there may be problems from the viewpoint of protection of an individual's information and privacy.

### DESCRIPTION OF THE DRAWINGS

FIG. 1 is a block diagram illustrating a conversation supporting device of a first embodiment.

FIG. 2 is a diagram illustrating hardware components of the conversation supporting device of the first embodiment.

FIG. 3 is a diagram illustrating example voice data stored in a voice information storage part.

FIG. 4 is a diagram illustrating a result of a determination of a conversation interval by a conversation interval determination part in the first embodiment.

FIG. 5 is a diagram illustrating disclosable information stored in a disclosable information storage part.

FIG. 6 is a schematic diagram illustrating acoustic models and language models stored in a recognition resource storage part.

FIG. 7 is a flow chart illustrating operations of the conversation supporting device in the first embodiment.

FIG. 8 is a block diagram illustrating a conversation supporting device of a second embodiment.

FIG. 9 is a flow chart illustrating operations of the conversation supporting device in the second embodiment.

FIG. 10 is a conceptual diagram illustrating an example process of the conversation supporting device.

FIG. 11 is a block diagram illustrating a conversation supporting device of a modified example.

FIG. 12 is a diagram illustrating disclosable information stored in a disclosable information storage module of a modified example.

### DETAILED DESCRIPTION

According to the present disclosure, there is provided a conversation supporting device that can correctly recognize when the speech contents is about the information specific to a speaker.

In general, according to an example embodiment, a conversation supporting device has a storage unit configured to store information disclosed by a speaker, a recognition resource constructing unit configured to use the disclosed information in constructing a recognition resource for voice recognition using one of an acoustic model and a language model, and a voice recognition unit configured to use the recognition resource to generate text data corresponding to the voice data (that is, to recognize the voice data).

Here, the storage unit can store disclosable information, which is information a speaker allows/permits to be disclosed to another speaker during a conversation.

Additionally, the conversation supporting device may include a voice information storage unit configured to store voice data correlated to an identity of a speaker in a conversation or talk contained in the voice data, and time information about when the talk or conversation contained in the voice data occurred. And also, the conversation supporting device may include a conversation interval determination unit configured to use the voice data, the identification information, and the time information to determine a conversation interval in the voice data when the voice data contains a plurality of speech from a plurality of speakers over multiple time spans.

The present disclosure also provides for an example method for supporting a conversation including acquiring information from a speaker which the speaker allows to be disclosed during a conversation, storing the information acquired from the speaker in a storage unit, acquiring voice data, constructing a recognition resource using the acquired information, and using the recognition resource to recognize the voice data. The acquired information can be used to establish (construct or select) the acoustic model and/or the language model used for the recognition of voice data.

The present disclosure will be explained with reference to figures. Explanation will be made for an example of a conversation supporting device wherein the voices in the conversation of speaker A and speaker B are recognized and the conversation contents are recorded. According to the present example, the conversation supporting device is realized using a set of computer or network terminals.

### First Embodiment

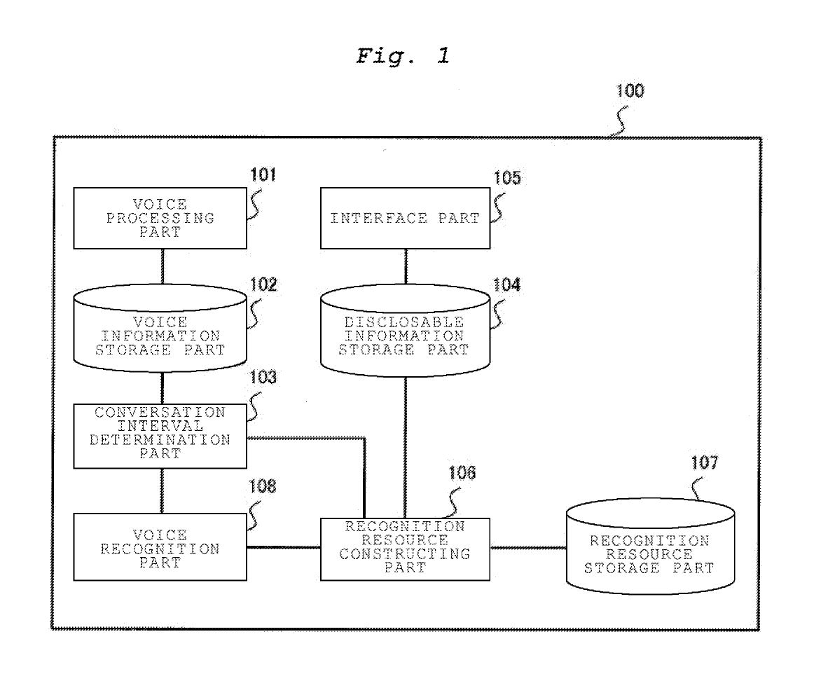

FIG. 1 is a block diagram illustrating a conversation supporting device 100 related to a first embodiment. This conversation supporting device uses specific information that a speaker permits to be disclosed about himself to recognize the speech of each speaker. For example, when speaker A permits it to be disclosed to speaker B that he (speaker A) is named “Yamamoto ( [symbol] )”, the conversation supporting device in the present embodiment uses this information to generate a language model which correctly recognizes that the sound corresponding to the word “Yamamoto” in the conversation should be represented in text as “Yamamoto ( [symbol] )” instead of “Yamamoto ( [symbol] )” (an alternative, but in this context incorrect, spelling/representation).

In addition, when the name of the company of speaker B is “OOO” and this company name is uncommon, it is possible to register “OOO” as a recognizable word in the general language model. According to the present embodiment, when speaker B permits it to be disclosed to speaker A that his company's name is “OOO”, the conversation supporting device adds “OOO” to a list of the recognizable words.

Using the disclosable information, the conversation supporting device in the present embodiment can make correct recognition of speeches even when the speeches are for the information specific to the speaker(s). In addition, when voice recognition is carried out, only the specific information allowed to be disclosed by the speaker(s) to another speaker is used, so that there is no problem from the viewpoint of protection of the individual information.

The conversation supporting device in this embodiment has a voice processing part 101, a voice information storage part 102, a conversation interval determination part 103, a disclosable information storage part 104, an interface part 105, a recognition resource constructing part 106, a recognition resource storage part 107, and a voice recognition part 108.

### Hardware Components

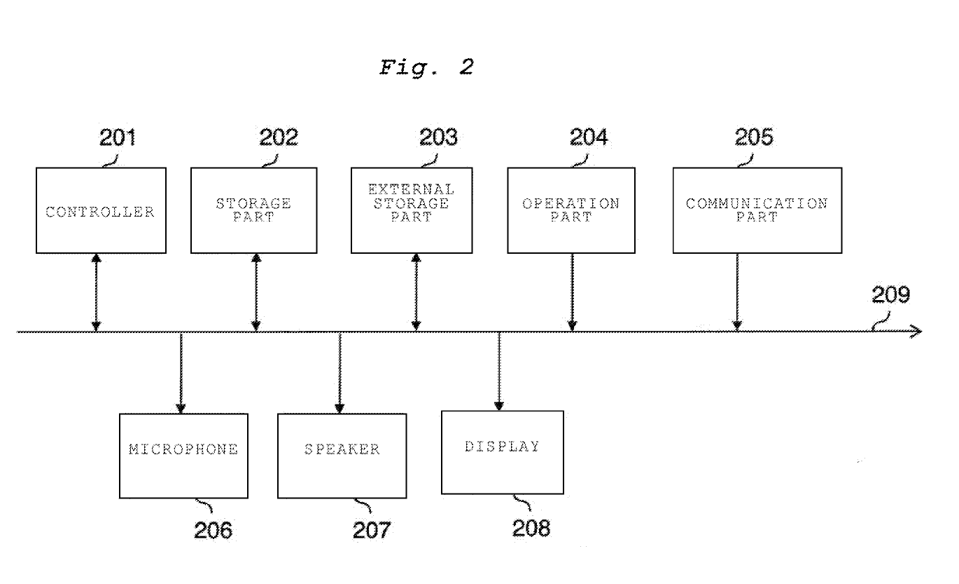

As shown in FIG. 2, the conversation supporting device in the present example is comprises a conventional computer terminal. The example has a central processing unit (CPU) or other controller 201 that controls the overall device; a read-only memory (ROM), random access memory (RAM) or other storage part 202 that stores various types of data and various types of programs; an external storage part 203, such as hard disk device (HDD), compact disk (CD) drive, or the like, that stores various types of data and various types of programs; an operation part 204, such as a keyboard, mouse, touch panel, etc.; a communication part 205 that controls communication with the external devices; a microphone 206 that picks up the voice; a speaker 207 that reproduces the voice; a display 208 that displays an image; and a bus 209 that connects the various parts. The conversation supporting device in the present embodiment maybe either a portable type or a desktop computer terminal.

In this example, the controller 201 executes various types of programs stored in the ROM or other storage part 202 and the external storage part 203 to realize various functions of a conversation supporting device.

### Functions of Various Parts

The voice processing part 101 acquires the voices (speeches) of speaker A and speaker B as digital voice data (voice data). Here, the voice processing part 101 also determines which speaker is speaking to generate the voice data.

In acquiring the voice data, voice processing part 101 makes an analog to digital (A/D) conversion on an analog signal corresponding to voices acquired with the microphone 206, and converts the analog signal to a digital signal of the voice data. While converting the analog signal to digital signals, the voice processing part also acquires time information for the voice data. The time information represents the time when the voice data were recorded.

The voice processing part 101 may have the voice data of the speakers registered beforehand in the storage part 202 and external storage part 203 and use existing speaker identification technology to determine the speaker of the voice data. The already registered voice data can be used to create and improve voice models for speaker A and speaker B, and, by matching the model with the acquired voice data, the speaker identification information of “A” and “B” can be attached to the voice data.

The voice information storage part 102 stores the voice data acquired by the voice processing part 101 as they are made. The acquired voice data is correlated to the identification information of the speaker of the voice data and the time information of voice data. The voice information storage part 102 can be, for example, implemented using storage part 202 and external storage part 203.

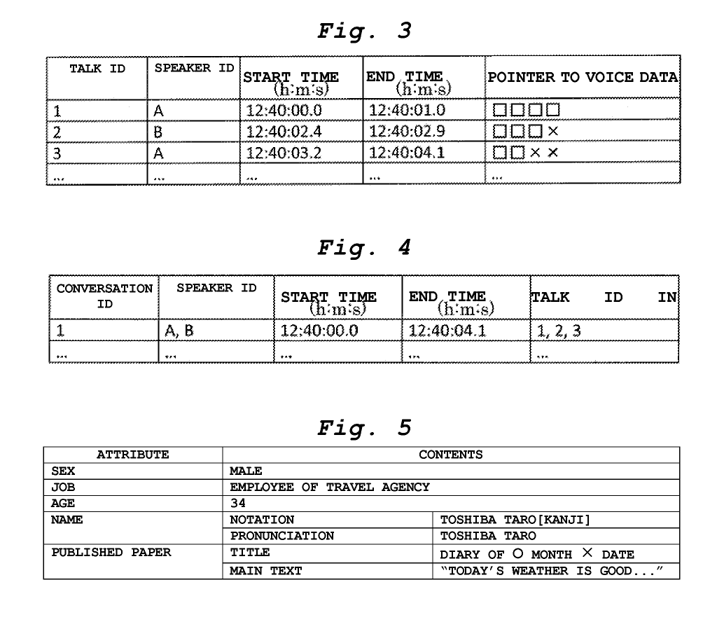

FIG. 3 is a diagram illustrating the information of the voice data stored in the voice information storage part 102. Here, a “talk ID” refers to a unique ID for identifying each conversation portion where a single speaker is speaking (a “talk”); a “speaker ID” is identification information for the speaker who speaks to generate the voice data; a “start time” refers to a start time of the talk; a “end time” refers to an end time of the talk; and a “pointer to voice data” represents an address for storage of the voice data of each talk. For example, the voice data corresponding to talk ID 1 is correlated with the following information: the speaker is A, the talk time is from 12:40:00.0 (hour/min/second) to 12:40:01.0. The start time and end time could also be represented by relative values, such as lapse time from a reference time point.

In the speaker ID, the identification information of the speaker determined by the voice processing part 101 is adopted. The start time and end time of each piece of voice data corresponding to a talk can be determined as follows: a voice interval detecting technology is adopted to detect a start position and end position of the voice, and the start time and end time are then computed from this position information and the time information acquired by the voice processing part 101.

The conversation interval determination part 103 uses the voice data, the identification information, and the time information stored in the voice information storage part 102 to determine the conversation interval when multiple speakers converse. For example, the technology described in Japanese Patent Reference JP-A-2005-202035 may be adopted for judging the conversation interval.

According to this related art, while plural pieces of voice data are recorded together with the identification information and the time information, the intensity of the voice data is quantized, and the conversation interval is detected from the corresponding relationship of the quantized pattern of the various voice data. For example, when conversation is made between two speakers, the pattern whereby the voice data with high intensity appear alternately is detected, and the interval where this pattern appears is taken as the conversation interval.

FIG. 4 is a diagram illustrating an example of a determination result by the conversation interval determination part 103. A “conversation ID” is a unique ID for identifying each conversation interval, and a “talk ID in conversation” represents the talk ID contained in each conversation. For example, the conversation ID “1” refers to the case wherein the conversation of speaker A and speaker B last from 12:40:00.0 to 12:40:04.1, and the talks occurring during the conversation are talk ID1 through ID3. By judging the conversation interval as shown in FIG. 4, the conversation interval determination part 103 can carry out a processing to specify the speakers and talks appearing within in each conversation interval.

The disclosable information storage part 104 stores the disclosable information—the information which a speaker permits to be disclosed to another speaker during their conversation(s). The disclosable information storage part 104 can be implemented, for example, using storage part 202 and external storage part 203. The disclosable information is acquired via interface part 105. In addition, the disclosable information may also be acquired from an external device connected via communication part 205.

The disclosable information includes at least an attribute and its contents. Here, the “attribute” represents a category of information, and the “contents” represent information in the attribute category. An example attribute would be “name” and the contents of this attribute might be “Yamamoto.” In addition to, for example, name, age, job, company name, position, birthplace, current address, hobby, and other items in the profile of the speaker, information related to the speaker may also include the texts of blogs, online diaries, online postings, websites, etc. related to the speaker.

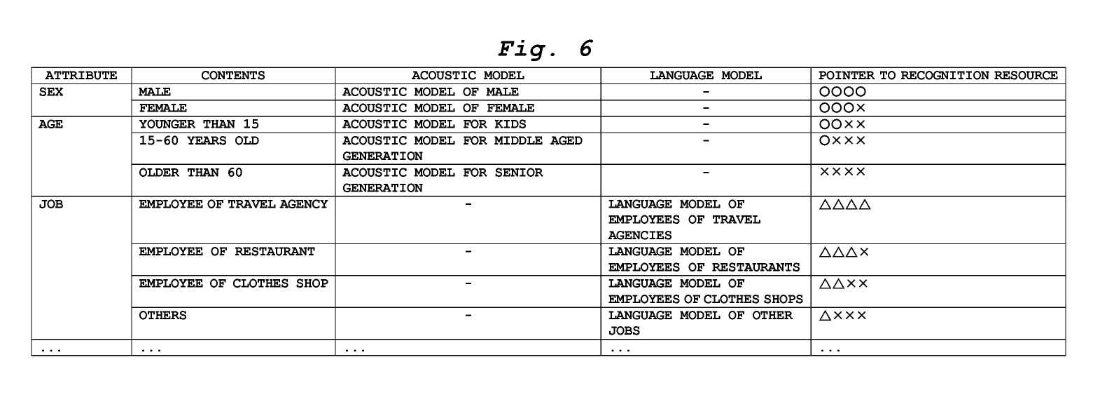

FIG. 5 is a diagram illustrating an example of the disclosable information stored in the disclosable information storage part 104. In this example, sub-categories of the contents of the attribute of “name” include “notation (kanji representation)” and “pronunciation.” Their contents, for example, are “TOSHIBA TARO [kanji representation]” and “toshiba taro,” respectively. For some attributes, the contents may be limited to certain classification values, such as “male” and “female” for “sex.” For other attributes, open-ended text strings instead of specific classification values may be adopted so, for example, the text corresponding to a diary entry of a certain date may be associated with the “published paper” attribute. Such disclosable information can be read, added, and edited for each speaker using the interface part 105. In this embodiment, the disclosable information includes the attribute and its contents. However, the disclosable information may also include only the contents without division into various attribute categories.

The interface part 105 allows reading, adding, and editing of the disclosable information for each speaker stored in the disclosable information storage part 104. The interface part 105 can be implemented using the operation part 204. For the interface part 105, it may be preferred that each speaker can read, add, and edit only his/her own disclosable information. In this case, it is possible to limit who can add and edit the disclosable information of a specific speaker by using such things as a personal log-in name and password system.

The recognition resource constructing part 106 uses the disclosable information to construct the recognition resource including an acoustic model and a language model adopted for recognition of the voice data. Here, in the construction operation, in addition to the scheme whereby the acoustic model or language model is newly generated, one may also adopt a scheme in which an acoustic model or language model that has been previously generated is selected and acquired from the recognition resource storage part 107. The recognition resource constructed by the recognition resource constructing part 106 can be stored in the storage part 202 or the external storage part 203.

According to the present example, the recognition resource constructing part 106 uses the disclosable information of the speakers who speak during the conversation interval detected by the conversation interval determination part 103 to construct the recognition resource. For example, for the conversation interval with the conversation ID 1, as both speaker A and speaker B are in conversation, the disclosable information of both these speakers is used to construct the recognition resource. By using the constructed recognition resource in the voice recognition part 108, it is possible to make correct recognition of the voice data concerning information specific to speaker A and speaker B in the conversation. The specific processing of the recognition resource constructing part 106 will be explained later.

The recognition resource is constructed from an acoustic model and a language model. The acoustic model is a statistical model for distribution of a characteristic quantity for each phoneme. In the case of voice recognition, usually, a hidden Markovian model is adopted, whereby variations in the characteristic quantity in each phoneme are taken as a state transition. Also, Gaussian mixture models may be adopted in the output distribution of the hidden Markovian model.

The language model is a statistical model that assigns a probability of words by means of a probability distribution. As a model that facilitates formation of a sequence from any word, the n-gram model is usually adopted. According to the present example, the language model may also contain grammar structure and a recognizable word list written in the context free grammar represented by the augmented BNF form (augmented Backus-Naur Form).

The recognition resource storage part 107 stores at least one acoustic model and one language model as they are is correlated to the related information. The acoustic model and language model stored in the recognition resource storage part 107 are adopted by the recognition resource constructing part 106 for constructing the recognition resource. The recognition resource storage part 107 can be implemented, for example, using the storage part 202 or the external storage part 203.

FIG. 6 is a schematic diagram illustrating the acoustic models and language models stored in the recognition resource storage part 107. The acoustic models and language models are stored in the “pointer to recognition resource” according to various potential attributes of the disclosable information. For example, for the attribute of “sex,” a different acoustic model is stored depending on whether the contents thereof are “male” or “female.” In the case of the attribute of “age,” storage is carried out so that the appropriate acoustic model can be used for each age range. In the case of the attribute of “job”, storage is carried out so that the appropriate language model can be used according to the speaker's job.

For example, suppose the speaker is an employee of a travel agency and the conversation relates to business travel, by using the “language model for tourism industry,” it is still possible to recognize the conversation speech at a high accuracy. Also, with the “others” category in the “job” attribute, a speaker with a job not corresponding to any previously specified category may have an acoustic model or language model corresponding to the “others” category prepared.

The voice recognition part 108 uses the recognition resource constructed by the recognition resource constructing part 106 to recognize the voice data. Existing technology may be adopted for voice recognition techniques and processes.

### Operation of Example Device

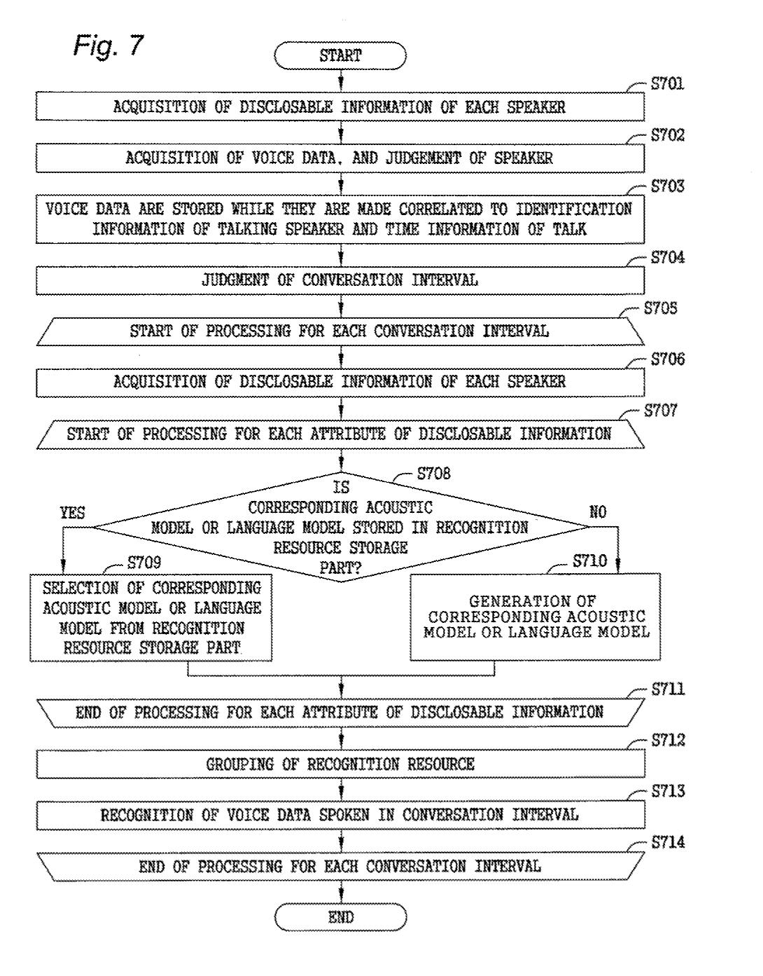

In the following, a conversation supporting device related to the present embodiment will be explained with reference to the flow chart shown in FIG. 7.

First, in step S701, the interface part 105 acquires the disclosable information of speaker A and speaker B. When the disclosable information is stored in the disclosable information storage part 104, speaker A and speaker B can read, add or edit the stored disclosable information.

In step S702, the voice processing part 101 acquires voice data and determines the speaker.

In step S703, the voice information storage part 102 stores the voice data acquired in step S702 correlated to the identification information of the speaker who spoke to generate the voice data and the time information of the talk.

In step S704, the conversation interval determination part 103 determines the conversation intervals contained in the voice data.

In step S705, for each of the conversation intervals detected in step S704, processing is started according to the following steps.

In step S706, the recognition resource constructing part 106 acquires the disclosable information of each speaker who spoke during the conversation interval from the disclosable information storage part 104.

In step S707, the recognition resource constructing part 106 starts the processing for each attribute contained in the disclosable information acquired in step S706.

In step S708, the recognition resource constructing part 106 determines whether an acoustic model or language model corresponding to each attribute is stored in the recognition resource storage part 107.

When a model is stored in the recognition resource storage part 107 (YES in step S708), in step S709, the recognition resource constructing part 106 selects the corresponding acoustic model or language model from the recognition resource storage part 107.

For example, suppose the attribute corresponding to the processing in step S707 is “sex,” and its content is “male,” the recognition resource constructing part 106 searches for the acoustic model or language model corresponding to this disclosable information in the recognition resource storage part 107. As shown in FIG. 6, the acoustic model of male is stored in the recognition resource storage part 107. Consequently, the recognition resource constructing part 106 selects this acoustic model for “male” and acquires it from the address “OOOO.”

Similar processing can be executed when the attribute is “job” or “age.” For example, when the attribute is “job” and the content is “employee of travel agency,” the language model for the employees related to travel service shown in FIG. 6 is selected, and it is acquired from the address “ΔΔΔΔ.”

When the model is not stored in the recognition resource storage part 107 (NO in step S708), then in step S710, the recognition resource constructing part 106 generates an acoustic model or language model corresponding to each attribute.

For example, suppose the attribute is “name,” and its contents include “TOSHIBA TARO[kanji]” and “toshiba taro[pronunciation],” the recognition resource constructing part 106 has these contents registered in the list of the recognizable words to generate a new language model. When text strings are contained as the disclosable information as the contents of the attribute of “published text,” the recognition resource constructing part 106 uses these text strings to generate a new language model.

The following is an example for construction of the acoustic model. Suppose the attribute of the disclosable information is “voice message,” and its contents are a relatively long voice message starting, “Hello, I am Toshiba Taro. My hobby is . . . . ” A large quantity of voice data may be recorded in the voice message in this manner. In this case, it is possible to use this large quantity of voice data to generate the voice model in the recognition resource constructing part 106. Also, the acoustic model stored in the recognition resource storage part 107can be adjusted using well known speaker adaptation technology. In this case, the parameters for adaptation may be derived from the voice data in the disclosable information.

In step S712, the recognition resource constructing part 106 uses the acoustic models or language models selected in step S709 and the acoustic models or language models generated in step S710 to unify the recognition resources for voice recognition.

For example, where there are plural recognition vocabulary lists containing different words, they are unified to form a single recognition vocabulary list. For the acoustic models, the several different acquired acoustic models (such as those for male and senior persons) can be used at the same time. For the language models, it is also possible that a method is used to carry out a weighted summation of the language models to unify them.

In step S713, the voice recognition part 108 uses the recognition resource constructed by the recognition resource constructing part 106 to recognize the voice data spoken in each conversation interval. The voice data spoken in the conversation interval can be specified by the information of the conversation interval shown in FIG. 4.

The conversation supporting device of the present embodiment uses the disclosable information to construct the recognition resource adopted for voice recognition. As a result, even when the information specific for the speaker is spoken, it is still possible to correctly recognize the speech. Also, as only the disclosable information is adopted, there is no problem from the viewpoint of protecting the personal information.

### MODIFIED EXAMPLE 1

In the example embodiment, explanation has been made for the case when conversation is carried out by two speakers, namely, speaker A and speaker B. However, there may also be three or more speakers.

The voice processing part 101 may also acquire the voice data of each speaker via a headset microphone (not shown in the figure) set for each of speaker A and speaker B (and additional speaker C, etc.). In this case, the headset microphones and the voice processing part 101 maybe connected either with a cable or wirelessly.

When a headset microphone is adopted for acquiring the voice data, the voice processing part 101 can work as follows: each speaker logs in using his/her personal number or personal name when the conversation supporting device is in use, and, when log-in is carried out, the corresponding relationship between the headset microphone assigned to each speaker and the log-in identity is taken to identify the speaker.

Also, the voice processing part 101 can use independent component analysis or other existing technology to separate the voices acquired by multi-channel microphones, such as those of a telephone conference system, to correspond to the individual speakers. By using a microphone input circuit that allows simultaneous input of multiple channels, it is possible to realize synchronization in time of the channels.

The voice information storage part 102 may also store voice data acquired offline instead of voice data acquired in real time by the voice processing part 101. In this case, the speaker ID, start time, and end time of the voice data may be issued manually. Also, the voice information storage part 102 may store the voice data acquired by other existing equipment.

In addition, in the voice processing part 101, a mechanical switch (not shown in the figure) may be prepared for each speaker, and the speaker would be asked to press the switch before and after speaking or to press a switch while speaking and release the switch when finished. The voice information storage part 102 can take the time points when the switch is pressed as the start time and end time of each round of talk.

Also, the recognition resource constructing part 106 may use the conversation interval issued manually offline instead of the conversation interval determined by the conversation interval determination part 103 to acquire the disclosable information for constructing the recognition resource.

### Second Embodiment

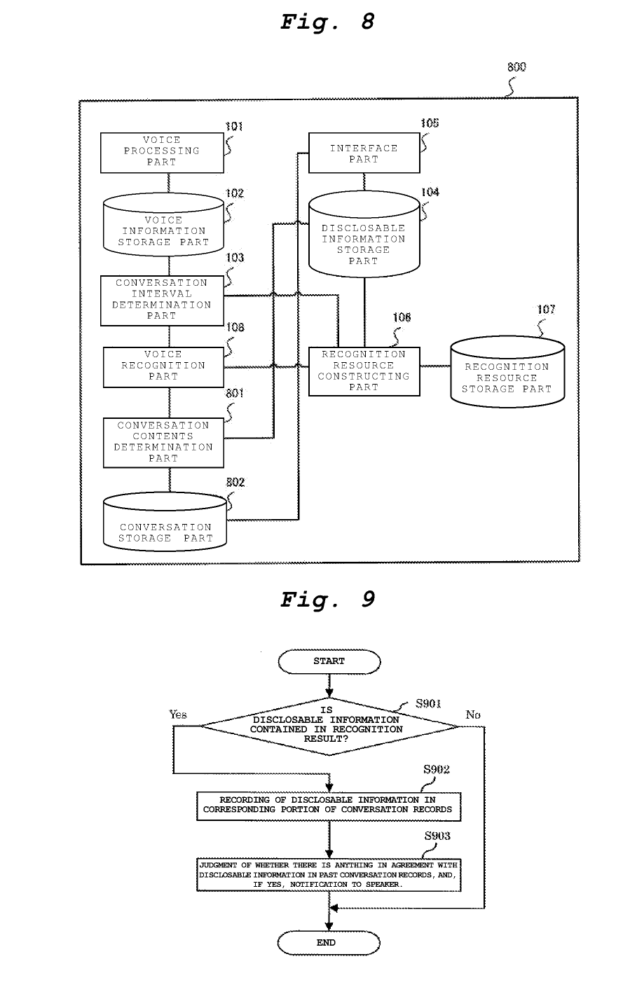

FIG. 8 is a block diagram illustrating a conversation supporting device 800 related to a second embodiment of the present disclosure. The conversation supporting device 800 in this embodiment differs from the conversation supporting device 100 in the first embodiment in that it has a conversation contents determination part 801 and a conversation storage part 802.

For the conversation supporting device of the present embodiment, when disclosable information are contained in the recognition result, the conversation records containing this disclosable information are left as is. But when the notation or pronunciation the same as that of the disclosable information is present in the same attribute as that of other conversation records, the speaker is notified with this fact.

### Functions of the Various Parts

The conversation contents determination part 801 determines whether disclosable information is contained in the recognition result from the voice recognition part 108. As the determination method, the method of comparison between the recognition result and the disclosable information of the speaker is adopted. Comparison may be realized using existing methods for comparison such as the notation text strings of words, comparison of the codes corresponding to the words, or comparison of read text strings of the words, or the like.

The conversation storage part 802 stores the recognition result generated by the voice recognition part 108 as conversation records. The conversation records are stored for each speaker. Each of the conversation records includes the talk time information and conversation counterpart. The conversation records further include the disclosable information, when the conversation contents determination part 801 determines the disclosable information is contained in the recognition result. The conversation storage part 802 can be implemented using the storage part 202 or the external storage part 203.

According to the present example, each speaker can carry out searching, reading, and editing of the conversation records stored in the conversation storage part 802 via the interface part 105.

### Operation of Second Example Device

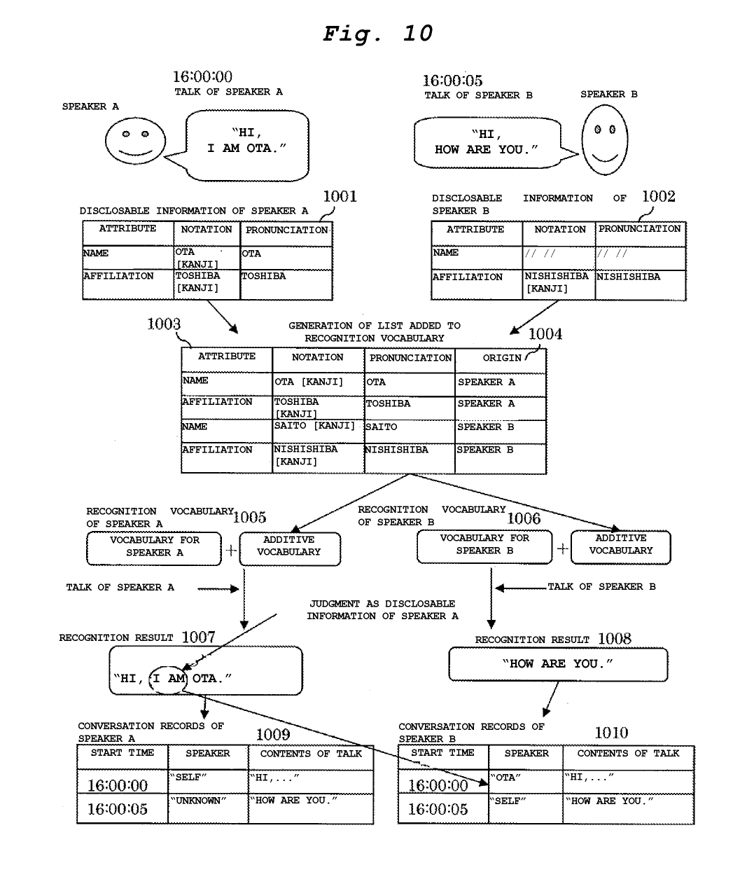

In the following, with reference to the flowchart shown in FIG. 9 and the schematic diagram shown in FIG. 10, the processing operation of the conversation supporting device in the present example will be explained. In this flow chart in FIG. 9, as the processing until acquisition of the recognition result is the same as that in the first embodiment, the steps up to that point are not shown again.

As shown in FIG. 10, the disclosable information of speaker A is represented as 1001, and the disclosable information of speaker B is represented as 1002. In this example, the disclosable information refers to the name of the speaker and the corresponding attributes of “name” and “affiliation.” The recognition resource constructing part 106 acquires the name of the speaker and the contents of the attributes from the disclosable information of each speaker, and it adds this information to the recognition vocabulary to generate a list 1003. Here, the recognition resource constructing part 106 of the present example also acquires the “origin” indicating whether each vocabulary is generated on the basis of disclosable information of either speaker, as shown in column 1004 shown in FIG. 10.

As indicated by 1005 and 1006 shown in FIG. 10, the recognition resource constructing part 106 adds vocabulary 1003 to the recognition vocabulary for both speakers is used to generate a language model. In this case, an example in which the recognition vocabulary of each speaker is used to generate the language model is presented. However, the language model may also be generated by adding vocabulary to a common recognition vocabulary shared by all of the speakers. When the recognition vocabulary for a specific speaker is used, recognition can be carried out with the vocabulary appropriate for that speaker, so that it is expected that an even higher recognition accuracy can be realized.

The voice recognition part 108 uses the generated language model as the recognition resource to recognize the voices of speaker A and speaker B. The respective recognition results are represented by 1007 and 1008, shown in FIG. 10.

Referring now to the flow chart shown in FIG. 9, the processing of the conversation supporting device according to the present example after acquisition of the recognition results will be explained.

First, in step S901, the conversation contents determination part 801 determines whether the disclosable information is contained in the recognition result. The determination methods can include a method whereby determination is made based on whether the various text strings of the recognition result are contained in the disclosable information of the speakers in conversation, and a method whereby the “origin” information of column 1004, shown in FIG. 10, is used as basis. In this example, it can be seen that for the recognition result 1007 of the talk of speaker A, the portion of “Ota” of the recognition result is a word recognized with the additive vocabulary. When the “origin” of “Ota” is checked, it is possible to determine that the disclosable information of speaker A is contained in the recognition result. When it is determined in this step that the disclosable information is not contained, the processing comes to an end.

In step S902, the conversation storage part 802 has the disclosable information recorded in the corresponding portion of the conversation records. In the conversation records, at least the information related to the time point information of the talk, the conversation counterpart, and the talk contents are recorded. In addition, the following information may also be recorded: talk ID, speaker ID, talk start time and end time, conversation ID, etc. As shown in FIG. 10, the disclosure time point, the speaker, and the talk contents are stored in the conversation storage part 802.

In step S901, the conversation contents determination part 801 determines that “Ota” within the “name” attribute is disclosable information of speaker A contained in the recognition result. Consequently, the conversation storage part 802 records “Ota” as a “speaker” in the conversation records 1010 of speaker B.

As an example, other than the items listed in FIG. 10 for possible inclusion in the disclosable information of speaker A, for an attribute of “casual name of job position,” having the attribute contents of a pronunciation of “tee-el [TL]” and a formal name of “team leader” may also be registered. When speaker A says “tee-el,” the conversation contents determination part 801 determines that “TL” is contained in the talk of speaker A. In this case, the conversation storage part 802 can use the casual name of job position of “TL” and the formal name of job position of “team leader” to record “TL (team leader)” in the conversation records.

In this way, the contents about the conversation counterpart and the information of the conversation counterpart can be recorded automatically. Also, as the operation is carried out according to the disclosable information, for a conversation counterpart that does not reveal the disclosable information, or if the speaker or the counterpart does not talk, the disclosable information is not sent to the other counterpart. Also, when the conversation record is constructed, by tracking the origin of the disclosable information in the result of the voice recognition, it is possible to identify each speaker who talks, so that it is possible to make a recording without contradiction between the speaker and the contents when the conversation records are left there.

In step S903, the conversation storage part 802 determines whether disclosable information contained in the recognition result in step S902 potentially matches the past stored conversation records. If YES, the speaker is notified.

In this way, the speaker(s) can be notified that the conversation records contain potentially conflicting information, such as when the pronunciations are different while the notations are the same, or when the pronunciations are the same while the notations are different with respect to the counterpart now in conversation, and the talk contents.

For example, suppose speaker B talks with another speaker C after the process shown as an example in FIG. 10. In addition, suppose the name of speaker C is also “Ota”, and this information is disclosable information. In this case, the name of speaker A, “Ota,” and the name of speaker C, “Ota,” may be mixed up. Here, this potentially confused or conflicting information is sent via the interface part 105 to speaker B.

Notification to a speaker can be carried out via the interface part 105. When the conversation records are displayed on the display 208, the interface part 105 can make the conflicting information standout clearly by changes in typeface, size, color, etc. of the letters on an interface screen. The interface part 105 may also be capable of generating a synthetic voice for playing out from the speaker 207 potentially conflicting contents with the same notation or pronunciation as that of the past conversation. In addition, the interface part 105 may use a vibration function such as that adopted by a cell phone to notify the speaker of potential conflicts.

The conversation records can be read by each speaker via the interface part 105. As a result, the speaker can find out the contents of conversations carried out in the past, and, for the contents of the disclosable information in the conversation being made, the speaker can use the notation, pronunciation, etc. of the name, or other disclosable information to make correct representation or to prevent misunderstandings. As the processing is carried out only with the information allowed to be disclosed by each speaker, it is possible to prevent inadvertent transmission of a topic not to appear in the conversation or of information not to be disclosed to the counterpart.

### MODIFIED EXAMPLE 2

In the previous example embodiments, the conversation supporting device was realized using a single set of terminals. However, the present disclosure is not limited to this scheme. The conversation supporting device may also include a plurality of terminals, and the parts (voice processing part 101, voice information storage part 102, conversation interval determination part 103, disclosable information storage part 104, interface part 105, recognition resource constructing part 106, recognition resource storage part 107, voice recognition part 108, conversation contents determination part 801, conversation storage part 802) may be contained in any of the terminals.

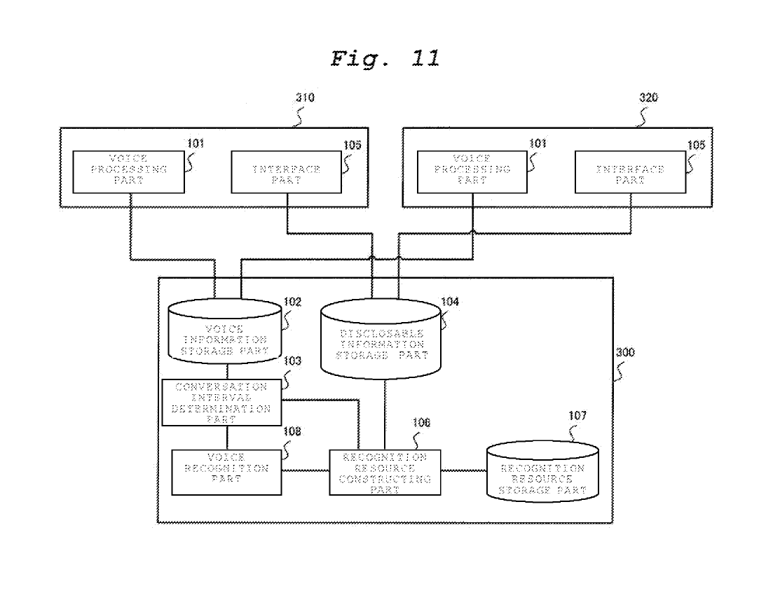

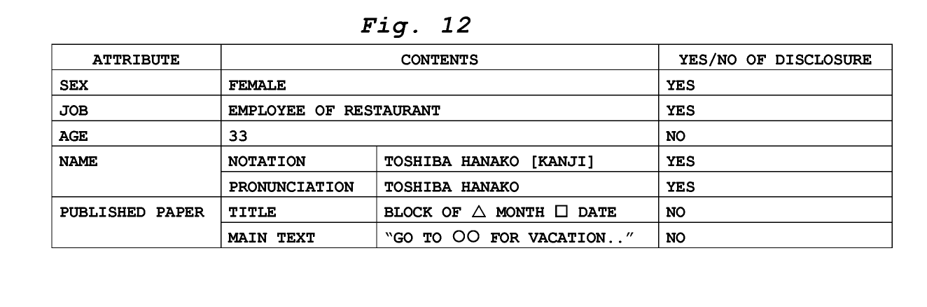

For example, as shown in FIG. 11, the conversation supporting device may be realized by three terminals, that is, a server 300, terminal 310 of speaker A, and terminal 320 of speaker B. In this case, transmission of information between the terminals can be carried out by cable or wireless communication.

In addition, it is also possible to exchange disclosable information directly between the terminals of speaker A and speaker B without a server. For example, the disclosable information of speaker A can be transmitted to the terminal of speaker B by the IR communication (or the like) equipped in the terminal. As a result, it is possible to realize voice recognition using the disclosable information stored in the terminal of speaker B.

### MODIFIED EXAMPLE 3

The conversation supporting device may have the non-disclosable information, that is, information not allowed by the speaker to be disclosed to another speaker among the information related to the speaker, stored in the storage part 202 or the external storage part 203. Control is carried out to ensure that when the recognition resource is constructed, the recognition resource constructing part 106 cannot use the non-disclosable information. Each speaker can read, add or edit his/her own non-disclosable information via the interface part 105.

Also, the disclosable information storage part 104 can store the information related to the speaker using the constitution shown in FIG. 12. Here, “yes/no of disclosure” column indicates whether the information can be disclosed to another speaker. The information in a row of “yes” is the disclosable information, and the information in a row of “no” is the non-disclosable information. The recognition resource constructing part 106 determines the disclosable information by using the “yes/no of disclosure” column as reference, and the disclosable information can then be used to construct the recognition resource.

### OTHER EXAMPLES

A portion or all of the functions of the example embodiments explained above can be realized by software processing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A conversation supporting device comprising:
a storage unit configured to store information disclosed by a speaker;
a recognition resource constructing unit configured to use the disclosed information in constructing a recognition resource for voice recognition using one of an acoustic model and a language model; and
a voice recognition unit configured to use the recognition resource to generate text data corresponding to the voice data.

2. The conversation supporting device of claim 1, further comprising:
a voice information storage unit configured to store the voice data correlated to identification information, the identification information including an identity of a speaker of a talk contained in the voice data, and a time information of the talk contained in the voice data; and
a conversation interval determination unit configured to use the voice data, the identification information, and the time information to determine a conversation interval in the voice data when the voice data contains a plurality of talks from a plurality of speakers;
wherein the recognition resource constructing unit is further configured to use the information disclosed by the plurality of speakers who spoke during the conversation interval to construct the recognition resource, and
the voice recognition unit is further configured to recognize the voice data corresponding to the conversation interval determined by the conversation interval determination unit.

3. The conversation supporting device of claim 1, wherein the recognition resource constructing unit is further configured to use the disclosed information to generate at least one language model or at least one acoustic model.

4. The conversation supporting device of claim 1, further comprising:
a recognition resource storage unit configured to store one or more acoustic model and one or more language model, the acoustic models and the language models correlated to a category of disclosed information;
wherein the recognition resource constructing unit is configured to select at least one acoustic model and at least one language model and to construct the recognition resource using the selected models.

5. The conversation supporting device of claim 1, wherein the disclosed information is categorized by an attribute representing a category of information related to the speaker.

6. The conversation supporting device of claim 1, further comprising:
a conversation contents determination unit configured to determine whether the text data generated by the voice recognition unit contains disclosed information.

7. The conversation supporting device of claim 6, further comprising:
a conversation storage unit configured to store a plurality of conversation records, each conversation record associated with one or more speakers and containing the text data corresponding to a single conversation interval;
wherein in the conversation contents determination unit is further configured to determine whether information disclosed by a particular speaker is contained in the plurality of conversation records and to identify each conversation record containing information disclosed by the particular speaker.

8. The conversation supporting device of claim 1, wherein the voice data comprises speech from a plurality of speakers.

9. The conversation supporting device of claim 1, wherein information disclosed by more than one speaker is used in constructing the recognition resource for the recognition of a voice data.

10. The conversation supporting device of claim 2, further comprising:
a recognition resource storage unit configured to store one or more acoustic model and one or more language model, the acoustic models and the language models correlated to a category of disclosed information;
wherein the recognition resource constructing unit is configured to select at least one acoustic model and at least one language model and to construct the recognition resource using the selected models.

11. The conversation supporting device of claim 10, further comprising:
a conversation contents determination unit configured to determine whether the text data generated by the voice recognition unit contains disclosed information.

12. The conversation supporting device of claim 11, further comprising:
a conversation storage unit configured to store a plurality of conversation records, each conversation record associated with one or more speakers and containing the text data corresponding to a single conversation interval;
wherein in the conversation contents determination unit is further configured to determine whether information disclosed by a particular speaker is contained in the plurality of conversation records and to identify each conversation record containing information disclosed by the particular speaker.

13. The conversation supporting device of claim 1, wherein a set of computer terminals is used to implement the functions of the storage unit, the recognition resource constructing unit, and the voice recognition unit.

14. A conversation supporting method comprising:
acquiring information from a speaker;
storing the information acquired from the speaker in a storage unit;
acquiring a voice data;
constructing a recognition resource using the acquired information, the recognition resource including an acoustic model for recognition of voice data and a language model for recognition of voice data; and
using the recognition resource to recognize the voice data, thereby generating a text data corresponding to the voice data.

15. The conversation supporting method of claim 14, further comprising:
using the acquired information to establish the acoustic model for recognition of voice data or to establish the language model for recognition of voice data.

16. The conversation supporting method of claim 14, further comprising:
determining whether the text data corresponding to the voice data contains information acquired from a particular speaker.

17. The conversation supporting method of claim 16, further comprising:
notifying the particular speaker when it is determined that the text data corresponding to the voice data contains information acquired from the particular speaker.

18. The conversation supporting method of claim 14, further comprising:
identifying one or more speakers of the voice data;
determining one or more conversation interval in the voice data; and
processing the voice data by each determined conversation interval.

19. A conversation supporting program stored in a computer readable non-transitory medium, the program when executed causing operations comprising:
acquiring information from a speaker, the acquired information being information which the speaker allows to be disclosed during a conversation;
acquiring a voice data;
constructing a recognition resource using the acquired information, the recognition resource including an acoustic model for recognition of voice data and a language model for recognition of voice data; and
using the recognition resource to recognize the voice data, thereby generating a text data corresponding to the voice data.

20. The conversation supporting program of claim 19, wherein the program when executed further causes operations comprising:
determining whether the text data corresponding to the voice data contains information acquired from a particular speaker; and
notifying the particular speaker when it is determined that the text data corresponding to the voice data contains information acquired from the particular speaker.
